(19) United States
(12) Patent Application Publication
(10) Pub. No.: US 2004/0208431 A1
(43) Pub. Date: Oct. 21, 2004

(54) Optical ether constructed using paired couplers and paired fibers

(75) Inventors: Duo-Chang Lin, Taoyuan Hsien (TW); Hung-Huei Liao, Taoyuan Hsien (TW); Tzuoh-Chyau Yeh, Taoyuan Hsien (TW); Hun-Yu Yang, Taoyuan Hsien (TW); Yen-Hsu Chiang, Taoyuan Hsien (TW); Yu-Lin Liu, Taoyuan Hsien (TW); Kuei-Huei Lin, Taoyuan Hsien (TW); Min-Kaung Lu, Taoyuan Hsien (TW)

Correspondence Address: BACON & THOMAS, PLLC, 625 SLATERS LANE, FOURTH FLOOR, ALEXANDRIA, VA, 22314

(73) Assignee: Chunghwa Telecom Co., Ltd.

(21) Appl. No.: 10/100,088

(22) Filed: Mar. 19, 2002

(51) Int. Cl. G02B 6/28; H04J 14/00

(52) U.S. Cl. 385/24; 385/46; 385/16

(57) ABSTRACT

An all optical transparent network is arranged such that each optical communication port can simultaneously and independently broadcast optical signals to, and receive optical signals from, any or all other optical communication ports on the network, and such that optical communications ports can arbitrarily and conveniently be added at distributed locations. The optical network constructed of paired 2×2 optical couplers that are cross-connected in a unique manner to form twin couplers, and/or N×N star couplers having at least one paired receiving and transmitting port such that each of the N communication ports communicates directly with each of the other communication ports.

### BACKGROUND OF THE INVENTION

1. Field of the Invention

This invention relates to an all optical transparent network (AOTN) of the type in which each optical communication port can simultaneously and independently broadcast optical signals to, and receive optical signals from, any or all other optical communication ports on the network, and in which optical communications ports can arbitrarily and conveniently be added at distributed locations.

More particularly, the invention relates to an optical network constructed of paired 2×2 optical couplers that are cross-connected in a unique manner to form twin couplers, and/or N×N star couplers having at least one paired receiving and transmitting port such that each of the N communication ports communicates directly with each of the other communication ports. The twin couplers and cross-connected star couplers form the basic building blocks of the network.

In the case of twin couplers, each twin coupler has two upstream ports and two downstream ports, each port having a transmit branch and a receive branch, and each receive branch being capable of transmitting a received signal to the transmit branches of both the upstream and the downstream ports, thus enabling any optical device connected to the twin coupler to transmit signals to, and receive signals from, any other optical device connected to the twin coupler, whether upstream or downstream, and irrespective of the number of intervening twin couplers.

The optical network of the invention is compatible with all current optical multiplexing techniques, including dense wave division multiplexing (DWDM) and sub-carrier multiplexing (SCM), as well as other optical communications technologies such as coherent heterodyne detection and high bandwidth fiber erbium doped fiber amplification (EDFA), and even technologies currently used only in wireless systems, such as carrier sense multiple access (CDMA) technology. As a result, the optical network of the invention is capable of ultrahigh information capacity and vast numbers of access ports, even as the modified star architecture of the network minimizes conduit length, and therefore construction costs, while also reducing the need for massive regenerators and/or complex bandwidth conservation protocols.

2. Description of Related Art

The low loss region of a single-mode optical fiber extends over wavelengths of from roughly 1.2 to 1.6 μm, which is an optical bandwidth of more than 30 THz. Efficient use of this bandwidth to accommodate multiple access is currently made possible by optical multiplexing technologies such as DWDM and SCM, while EDFA technology has enabled the enormous splitting losses caused by the above-mentioned multiplexing techniques to be compensated without undue loss of bandwidth.

While these technologies promise ever increasing communication speeds and capacity, their full potential has yet to be realized, primarily because of cost, and in particular the high cost of laying and maintaining the necessary fiber conduits. Current network architectures require subscribers to be directly connected to a central hub, or to share fibers and bandwidth, limiting the ability to add subscribers by adding branch lines or local area networks connected to the main branch line, particularly with respect to private homes, and requiring massive regenerators and complex switching arrangements at each hub. As a result, fiber optic communications are primarily used for high speed communications between network nodes, while communications between the network nodes and subscribers, and local area network communications, continue to be carried by the same type of copper wires used since the 19^{th} century to carry ordinary telephone signals.

### SUMMARY OF THE INVENTION

It is accordingly a first objective of the invention to provide a low cost, easily expandable, high capacity all optical network.

It is a second objective of the invention to provide an all optical transparent network (AOTN) in which each optical communication port can simultaneously and independently broadcast optical signals to, and receive optical signals from, any or all other optical communication ports on the network, and in which communications ports can be arbitrarily and conveniently added at distributed locations.

It is a third objective of the invention to provide an all optical transparent network compatible with all existing multiplexing techniques for routing optical signals with low loss and high bandwidth, as well as with other existing technologies such as EDFA and coherent heterodyne detection, and even wireless multiplexing technologies such as CDMA, and yet in which communications ports can be arbitrarily and conveniently added at distributed locations.

It is a fourth objective of the invention to provide an optical network capable of irregular distribution and unpredictable expansion, enabling different local optical networks to be connected directly together at selected wavelengths.

It is a fifth objective of the invention to minimize the cost of using optical fibers as an Internet transmission medium.

It is a sixth objective of the invention to provide an alternative way of extending fiber networks directly to end users, including private homes.

It is a seventh objective of the invention to provide a twin coupler for use in constructing an optical network having the above-described characteristics.

These objectives are achieved by constructing the optical network out of a unique arrangement of paired fibers and paired 2×2 couplers, which substantially simplifies network connections and permits reductions in conduit lengths.

The basic building block of the network is a twin coupler consisting of two 2×2 optical couplers, one of which serves as a transmit coupler and the other of which serves as a receive coupler, each coupler having two upstream branches and two downstream branches cross-connected to form a pair of upstream ports respectively made up of one branch from each 2×2 coupler, and a pair of downstream ports respectively made up of the remaining branches of the two 2×2 couplers.

To connect the twin coupler to another couplers, either of the upstream or downstream ports is connected to respective downstream or upstream ports on the other coupler, with receive and transmit branches on one coupler always being respectively connected to corresponding receive and transmit branches on the other coupler, and downstream ports always being connected to upstream ports.

In addition to the basic twin coupler, the optical network of the invention may include self return or terminal couplers consisting of a twin coupler in which the transmit and receive branches of one of the downstream ports are connected together, thus causing a signal input through a receive branch in one of the upstream ports to be output through the transmit branches on each of the upstream ports, as well as to the remaining downstream port so as to enable communications between upstream users to be carried out even when connections between downstream couplers are broken.

Furthermore, the optical network of the invention may include one or more star couplers having N transmitting ports on one side and N receiving ports on the other side, the star couplers being arranged to split an optical signal received in any one transmitting port of the star coupler into all of the N receiving ports of the respective star coupler, with one transmitting port and one receiving port being paired as a communication port. According to this arrangement, each N×N star coupler has N optical communication port and all of the N communication ports communicate with each other directly.

The twin couplers, star couplers, and/or self return twin couplers may then be arbitrarily combined to form infinitely expandable local and wide area networks. These networks may be linked to other such networks, including the Internet, through a variety of different multiplexers, routers, and/or couplers, enabling upgrade of existing networks in step-by-step fashion, without redundancy or extended service interruptions, and at minimal cost.

The optical network of the invention is compatible with, and makes full use of the capabilities of, existing high capacity multiplexing techniques, including SCM, DWDM, FDMA, OFDMA, CDMA, WDMA, TDMA, and combinations or variations of such techniques, as well as other state-of-the-art high-bandwidth optical networking technologies including EDFA and coherent heterodyne detection (although use of such technologies is not required), without limitation as to bandwidth and transmitting power, and therefore without the need for complex switch centers or concentrators, massive regenerators, and other power compensation or bandwidth conserving devices or arrangements.

Finally, it is noted that because the optical network of the invention permits broadcast to and receipt of signals from any port on the network and yet is capable of unlimited expansion, using any of a variety of existing or conceivable multiplexing and amplification techniques, the optical network of the invention may be compared to a free space (Aether@) based, wireless communications network. As a result, the optical network of the invention may conveniently and appropriately be referred to herein as an Aoptical ether.@

### BRIEF DESCRIPTION OF THE DRAWINGS

FIG. 1 is a schematic diagram of a paired 2×2 coupler on which the preferred network is based.

FIG. 2 is a schematic diagram of a local optical ether constructued by using twin couplers of the type shown in FIG. 1.

FIG. 3 is a schematic diagram of a variation of the paired 2×2 coupler of FIG. 1.

FIG. 4 is a schematic diagram of a hybrid distributed-star structure utilizing a cross-connected N×N star coupler and paired 2×2 couplers in accordance with the principles of a preferred embodiment of the invention.

FIG. 5 is a schematic diagram showing a further example of a network constructed using the paired 2×2 coupler of FIG. 1.

FIG. 6 is a schematic diagram showing application of a WDM cross-connection multiplexing scheme for combining local optical ethers according to the principles of the invention.

FIG. 7 is a schematic diagram illustrating a further scheme for combining local optical ethers according to the principles of the invention.

### DETAILED DESCRIPTION OF THE PREFERRED EMBODIMENTS

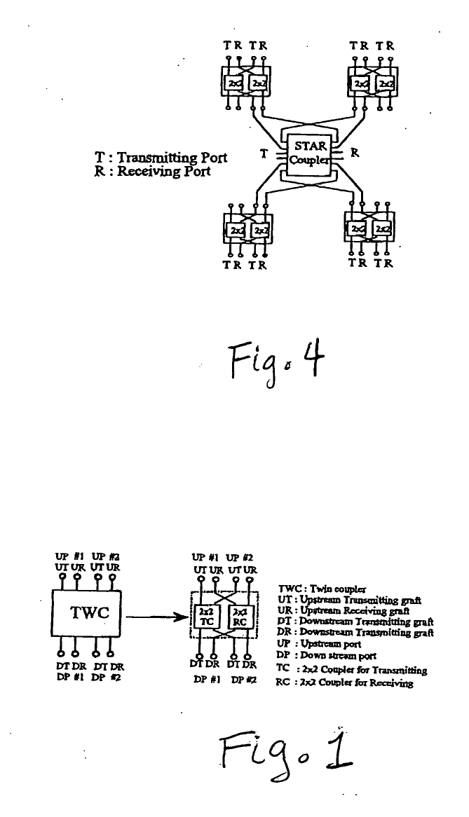

As illustrated in FIG. 1, the twin couplers which form the building blocks for the optical network of the invention include a pair of directional 2×2 couplers TC and RC, each having a two upstream branches or grafts UT,UR and two downstream branches or grafts DT,DR. One of the couplers is designated as the transmitting coupler and the other is designated as the receiving coupler, and the corresponding branches are designated as the upstream and downstream transmitting or receiving branches, as appropriate.

The 2×2 couplers are conventional devices and may, for example, be formed of two lengths of fiber fused in central section to enable a signal received by one upstream branch to be distributed to both of the downstream branches. Thus, in the illustrated example, a signal input through either of branches UT or UR is output through each of branches DT or DR.

The respective upstream and downstream transmitting branches are arranged to form two upstream ports UP #1 and UP #2, and two downstream ports DP #1 and DP #2. Each of the upstream ports includes one transmitting branch UT from the transmitting coupler, and one receiving branch UR from the receiving coupler. Similarly, each of the downstream ports includes one transmitting branch DT from the transmitting coupler and one receiving branch DR from the receiving coupler. When a signal is received by any of the upstream or downstream ports, that signal is distributed to both of the corresponding downstream or upstream ports.

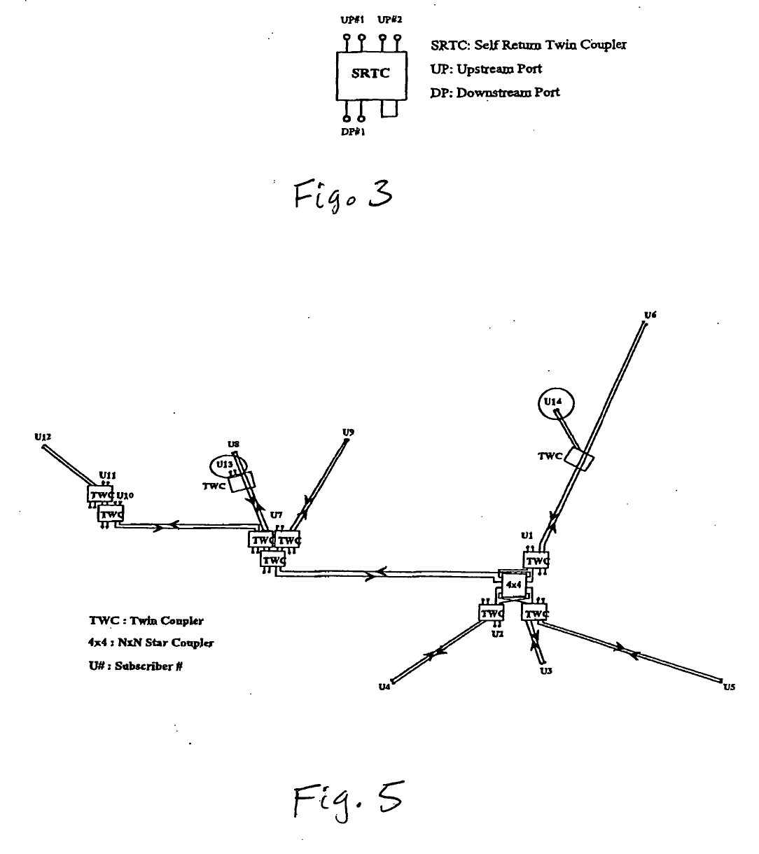

By including two cross-connected upstream ports and two cross-connected downstream ports, the twin coupler of the preferred embodiment effectively serves as an expansion module for the optical network. To expand the network, as illustrated in FIG. 3, one simply connects the two upstream communication ports of one twin coupler to respective downstream communication ports of two different twin couplers, and the two upstream communications ports. This permits the two upstream communication ports illustrated in FIG. 1 to become four upstream communication ports, which can be expanded using additional twin couplers to be become as many as eight communication ports, and so forth. The cascade rules for network expansion are simply that one upstream transmitting branch UT and one upstream receiving branch UR be respectively connected to a downstream transmitting branch DT and a downstream receiving branch DR of another twin coupler. By means of the coupling effect of the transmitting and receiving ports, the twin coupler simultaneously acts as a combiner for the signals transmitted from its upstream and as a distributor for the signals transmitted from its downstream.

In order for all of the twin couplers in the network of FIG. 2 to communicate with each other, a return path must be provided for the lowest coupler. This can be achieved by converting the lowest coupler into a self return or terminal couplers consisting of a twin coupler SRTC in which the transmit and receive branches of one of the downstream ports are connected together, as illustrated in FIG. 3, thus causing a signal input through a receive branch in one of the upstream ports UP #1 and UP #2 to be coupled back through the transmit coupler to each of the transmitting branches of the two upstream ports, as well as to the receiving branch on remaining downstream port DP #1. This enables upstream subscribers to communicate with each other even when the downstream Acircuit@ or connections are broken.

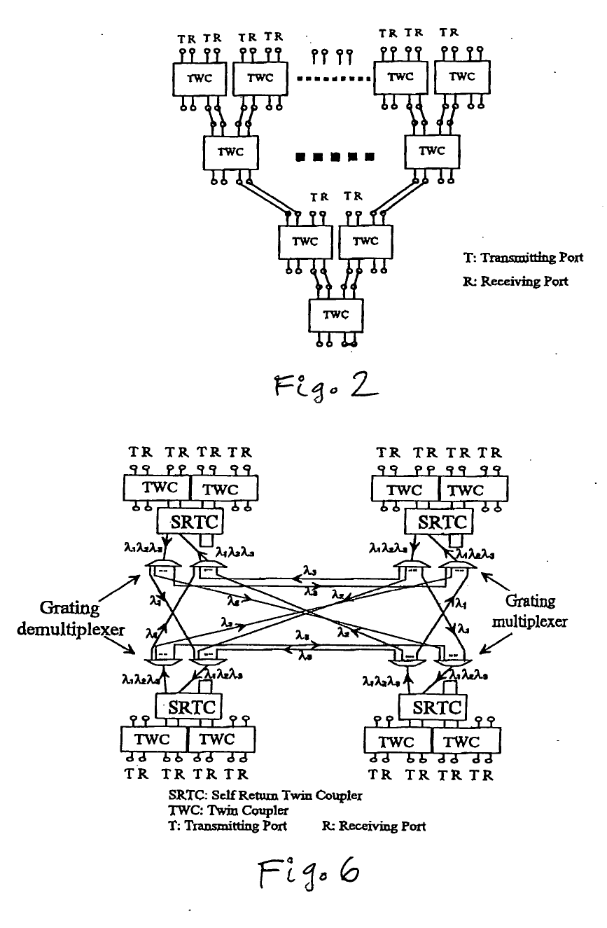

Alternatively, communication paths between upstream twin couplers, and to existing networks, may be established through a cross-connected N×N star coupler as illustrated in FIGS. 4 and 5. The N×N star coupler illustrated in FIGS. 4 and 5 is a conventional device that includes an arbitrary number N of receiving ports one side and a corresponding number N of transmitting ports on the other side, six of which are illustrated on each side. These transmitting and receiving ports may be paired to form N communications ports, with one transmitting port being cross connected to one receiving port such that each of the N communication ports is in communication with all of the other communication ports of the coupler, thereby forming a hybrid star connection architecture for connecting a plurality of local networks or subscribers, indicated in FIG. 5 by reference numbers U1-U14, with U13 and U14 being circled to indicate new users added to the existing network by expansion using twin couplers according to the principles of the invention.

Of course, the arrangement shown in FIG. 5 is for illustrative purposes, and is not to be taken as limiting either with respect to the number and exact arrangement of the twin and star couplers, or the number of subscribers. The twelve existing subscribers U1-U12 and two new users U13,U14 are shown in FIG. 5 are able to share the fiber cable efficiently and can communicate with each other directly through any of a variety of multiplexing technologies, without losing the ultrahigh bandwidth of the fiber. To expand the resulting Aether,@ only one twin coupler TWC and the shortest length of conduit to the ether are needed for new users U13 and U14. Furthermore, by connecting the residual downstream branches of the expansion twin coupler to form a self return twin coupler of the type illustrated in FIG. 3, the two upstream users can still communicate with each other even when the downstream path is broken.

In any of the network arrangements illustrated in FIGS. 2, 4, and 5, if the power budget is insufficient to sustain communications between all ports, optical amplifiers may be added in the self return path of the lowest twin coupler or the downstream communications ports of any of an upstream twin coupler. In addition, the self return path of the lowest twin coupler may also include This self return path can conveniently include an optical filter, amplifier, wavelength converter, or external modulator for various applications.

In the example illustrated in FIG. 6, the twin couplers are connected to a wave division multiplexer cross-connection scheme. A pair of grating wavelength demultiplexers and multiplexers are placed at the residual downstream port of each of a plurality of self return twin couplers SRTC, which in turn may be connected to an arbitrary number of twin couplers TWC to form local networks, or local optical ethers, of the type generally illustrated in FIG. 2. The branches or legs with specified transparent wavelengths from the grating demultiplexer of one local network are connected to the corresponding legs of the grating multiplexer of another local optical ether. As a result, users in each of the local networks not only can communicate with each other through the return paths of the respective self return twin couplers SRTC, but also can communicate with users of the other local networks by adjusting their wavelengths to the specified channel of the corresponding grating multiplexer. Except for the wavelengths assigned to the grating multiplexer, all other wavelengths can be reused within each local network.

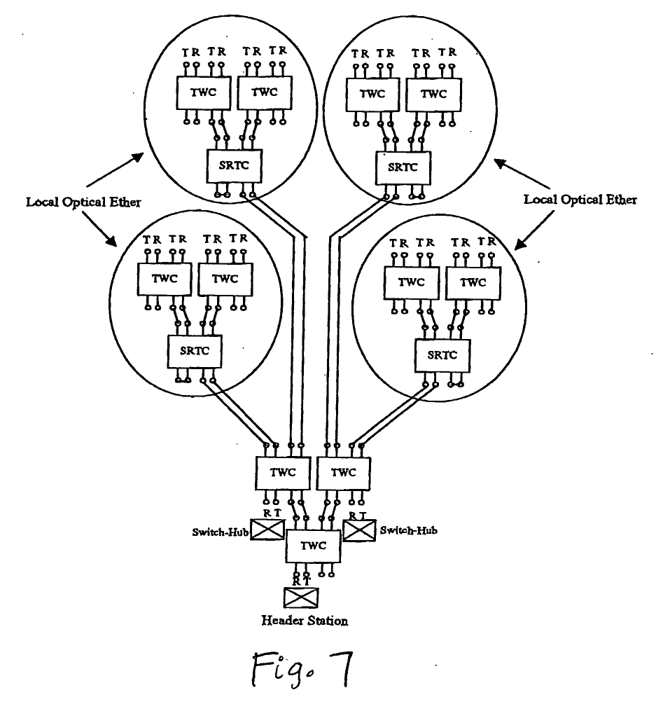

Finally, in the example illustrated in FIG. 7, individual local networks or Aoptical ethers,@ indicated by circles, are joined by using tree expanding twin couplers TWC at the downstream sides of the self return twin couplers SRTC. The users in each local network not only can communicate with each other through the return path of the corresponding self return twin coupler, but also can communicate with users in the other local networks through a switch hub at each of the downstream communication ports of the tree expanding twin couplers or, by using SCM multiplexing to achieve simultaneous communications, via a header station placed at the unused downstream ports of the lowest twin coupler.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention. For example, a local concentrator or switch center may be substituted for the switch hubs and/or header station in the example of FIG. 7, or for the star coupler illustrated in FIG. 5. As a result, it is intended that the invention not be limited by the above description or accompanying drawings, but that it be defined solely in accordance with the appended claims.

We claim:

1. An all optical transparent network, comprising:
at least one N×N star coupler having N transmitting ports on one side and N receiving ports on the other side, the star coupler being arranged to split an optical signal received in any one transmitting port of the star coupler into all of the N receiving ports of the star coupler, with one transmitting port and one receiving port being paired as a communication port, wherein said N×N star coupler has N optical communication port and all of the N communication ports communicate with each other directly.

2. An all optical transparent network, comprising:
at least one twin coupler including two 2×2 optical couplers, one of which serves as a transmit coupler and the other of which serves as a receive coupler, each coupler having two upstream branches and two downstream branches cross-connected to form a pair of upstream ports respectively made up of one branch from each 2×2 coupler, and a pair of downstream ports respectively made up of the remaining branches of the two 2×2 couplers.

3. An all optical transparent network as claimed in claim 2, further comprising at least one N×N star coupler having N transmitting ports on one side and N receiving ports on the other side, the star coupler being arranged to split an optical signal received in any one transmitting port of the star coupler into all of the N receiving ports of the star coupler, with one transmitting port and one receiving port being paired as a communication port, wherein said N×N star coupler has N optical communication port and all of the N communication ports communicate with each other directly, and wherein a plurality of said twin couplers are connected to at least one of said N communication ports to permit arbitrary distributed expansion of the communication network thus formed.

4. An all optical transparent network as claimed in claim 2, further comprising at least one additional said twin coupler, wherein either of the upstream or downstream ports are connected to respective downstream or upstream ports on the other coupler, with receive and transmit branches on one coupler always being respectively connected to corresponding receive and transmit branches on the other coupler, and downstream ports always being connected to upstream ports.

5. An all optical transparent network as claimed in claim 4, wherein at least one additional said twin connector is connected to each respective downstream and upstream port of a first said connector.

6. An all optical transparent network as claimed in claim 5, wherein two said additional twin couplers are connected to upstream ports of said first twin connector, and four additional twin couplers are connected to upstream ports of said two said additional twin couplers in cascade fashion.

7. An all optical transparent network as claimed in claim 2, wherein said twin coupler is a self return twin coupler, wherein the transmit branch of one of said downstream ports is connected to a receive branch of said one of said downstream ports.

8. An all optical transparent network as claimed in claim 7, wherein a downstream port of each of at least two additional said twin couplers is connected to a respective said downstream port of said self return twin coupler to form a local optical transparent network.

9. An all optical transparent network as claimed in claim 8, wherein at least two said all optical transparent networks are cross connected to each other through wave division multiplexers and demultiplexers.

10. An all optical transparent network as claimed in claim 2, wherein at least two said local transparent optical networks are connected to each other by additional said twin couplers connected to downstream ports of respective said self return twin couplers in said local transparent optical networks.

11. An all optical transparent network as claimed in claim 10, further comprising switch hubs connected to downstream ports of said additional said twin couplers connected to downstream ports of respective said self return twin couplers.

12. An all optical transparent network as claimed in claim 10, wherein additional said twin couplers connected to downstream ports of respective said self return twin couplers are connected to each other by yet another said twin coupler having a header station connected at the a downstream port.

13. A twin coupler, comprising two 2×2 optical couplers, one of which serves as a transmit coupler and the other of which serves as a receive coupler, each coupler having two upstream branches and two downstream branches cross-connected to form a pair of upstream ports respectively made up of one branch from each 2×2 coupler, and a pair of downstream ports respectively made up of the remaining branches of the two 2×2 couplers.

14. A twin coupler as claimed in claim 13, wherein the transmit branch of one of said downstream ports is connected to a receive branch of said one of said downstream ports to form a self return twin coupler.
